(19) United States
(12) Patent Application Publication
(10) Pub. No.: US 2013/0040035 A1
(43) Pub. Date: Feb. 14, 2013

(54) SOUTHERN DELIGHT

(71) Applicants: Edwina Wood, Steinhatchee, FL (US); James Bratcher, Steinhatchee, FL (US); Marcia Bratcher, Steinhatchee, FL (US)

(72) Inventors: Edwina Wood, Steinhatchee, FL (US); James Bratcher, Steinhatchee, FL (US); Marcia Bratcher, Steinhatchee, FL (US)

(21) Appl. No.: 13/368,514

(22) Filed: Feb. 8, 2012

Related U.S. Application Data
(63) Continuation-in-part of application No. 12/913,630, filed on Oct. 27, 2010, now abandoned.
(60) Provisional application No. 61/259,701, filed on Nov. 10, 2009.

(51) Int. Cl. A23L 1/24

(52) U.S. Cl. 426/589

(57) ABSTRACT

A salad dressing with prime ingredients comprising mayonnaise, ketchup, sugar, mustard, granulated garlic salt, Worcestershire sauce, and vinegar.

### CROSS-REFERENCE TO RELATED APPLICATION

The present application is a Continuation-in-Part (CIP) related to and claims priority from prior provisional application Ser. No. 61/259,701, filed Nov. 10, 2009 which application is incorporated herein by reference, and pending non-provisional application Ser. No. 12/913,630 filed Oct. 27, 2010 which applications are incorporated herein by reference.

### BACKGROUND OF THE INVENTION

1. Field of the Invention

The present invention relates generally to the field of food products and more specifically relates to a recipe for a salad dressing entitled Southern Delight.

2. Description of the Related Art

A significant amount of people enjoy dressing on their salads. A good tasting salad dressing will make salad more flavorful and encourage people to eat more salad which is a healthy alternative to fatty snack foods. A substantial amount of the available salad dressings on the market have similar generic tastes and may be outdated and therefore consumer choices become limited. Therefore most people have to pick the same popular salad dressings, such as Ranch Dressing, Vinaigrette, and Caesar Dressing repetitively, which lacks variety.

The concept of salad dressing varies across cultures. In Western culture, there are three basic types of salad dressing: Vinaigrette, Creamy Dressings, usually mayonnaise-based, but which may also contain yogurt, sour cream, buttermilk, milk, or crème fraîche, and Cooked Dressings, which resemble creamy dressings, but are usually thickened by adding egg yolks and gently heating. Vinaigrette is a mixture (emulsion) of salad oil and vinegar, often flavored with herbs, spices, salt, pepper, sugar, and other ingredients. It may be used most commonly as a salad dressing or alternatively as a sauce or marinade.

There are many commonly used salad dressings in North America. In the US the most popular dressings are Ranch Dressing, Vinaigrette, and Caesar Dressing which unfortunately have become monotonous and don't support the healthy consumption of salads. Therefore a need exists for new ways to improve the taste of salad dressings in order to create a new way to dress up salads and encourage the consumption of a variety of salads.

A need exists for a new flavorful salad dressing which is imaginative and contains a unique taste. A need exists for a delicious dressing that may be used on salads and crackers and which offers consumers the chance to enjoy the tasty dressing at home or in retail establishments.

Various attempts have been made to solve the above-mentioned problems such as those found in U.S. Pat. Nos. 6,090,432, 2006/0204641, and 6,475,549. This prior art is representative of salad dressings. None of the above inventions and patents, taken either singly or in combination, is seen to describe the invention as claimed.

Ideally, a salad dressing should entice people to enjoy a variety of salads which would normally not appeal to them, require a minimum amount of preparation, promote a healthy lifestyle, and be manufactured at a modest expense. Thus, a need exists for a new flavorful salad dressing which makes the consumption of salad more enjoyable and so to avoid the above-mentioned problems.

### BRIEF SUMMARY OF THE INVENTION

In view of the foregoing disadvantages inherent in the known salad dressing art, the present invention provides a novel Southern Delight salad dressing. The general purpose of the present invention, which will be described subsequently in greater detail, is to provide a new tasty salad dressing which makes the consumption of salad more enjoyable and promotes a healthy lifestyle.

A recipe for a Southern Delight salad dressing is disclosed herein comprising ingredients combined in proportions substantially including: two gallons of mayonnaise, one gallon of ketchup, four cups of sugar, two cups of mustard, four tablespoons of granulated garlic salt, four tablespoons of Worcestershire sauce, ⅔ cups of vinegar. The Southern Delight salad dressing is prepared by intermixing the two gallons of mayonnaise, the one gallon of ketchup, the four cups of sugar, the two cups of mustard, the four tablespoons of granulated garlic salt, the four tablespoons of Worcestershire sauce, and the ⅔ cups of vinegar.

A method of producing a Southern Delight salad dressing is also disclosed herein comprising the steps of: intermixing two gallons of mayonnaise, one gallon of ketchup, four cups of sugar, two cups of mustard, four tablespoons of granulated garlic salt, four tablespoons of Worcestershire sauce, and ⅔ cups of vinegar and thereby producing a mixture and sealingly storing the mixture within a container.

The present invention holds significant improvements and serves as a Southern Delight salad dressing. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Southern Delight, constructed and operative according to the teachings of the present invention.

FIG. 1 shows a perspective view illustrating a Southern Delight salad dressing according to an embodiment of the present invention.

FIG. 2 is a perspective view illustrating the Southern Delight salad dressing according to an embodiment of the present invention of FIG. 1.

FIG. 3 is a perspective view illustrating a method of use according to an embodiment of the present invention of FIGS. 1 & 2.

The various embodiments of the present invention will hereinafter be described in conjunction with the appended drawings, wherein like designations denote like elements.

### DETAILED DESCRIPTION

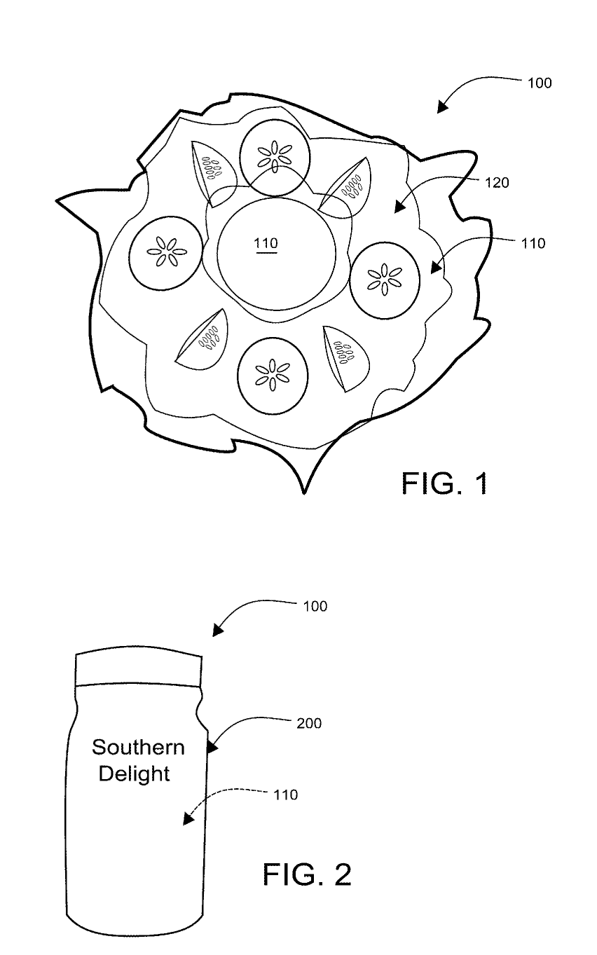

As discussed above, embodiments of the present invention relate to a food product and more particularly to a recipe for a salad dressing. Referring to the drawings by numerals of reference there is shown in FIG. 1, a perspective view illustrating a Southern Delight salad dressing 110 according to an embodiment of the present invention.

A recipe for Southern Delight salad dressing 110 is disclosed herein comprising ingredients combined in proportions substantially including: two gallons of mayonnaise, one gallon of ketchup, four cups of sugar, two cups of mustard, four tablespoons of granulated garlic salt, four tablespoons of Worcestershire sauce and ⅔ cups of vinegar.

The Southern Delight salad dressing 110 is prepared by intermixing the two gallons of mayonnaise, the one gallon of ketchup, the four cups of sugar, the two cups of mustard, the four tablespoons of granulated garlic salt, the four tablespoons of Worcestershire sauce, and the ⅔ cups of vinegar and blending these ingredients until a desired consistency and appearance is reached.

The quantities given are for a preferred mixture but may be varied according to the desired flavor and end product. The proportions given are relative to each other and if varying the total quantity of the finished product, one must be aware of the necessity to increase or decrease each ingredient proportionately.

Thus, a wide number of variations are possible. The main ingredients, preferably comprising two gallons of mayonnaise, one gallon of ketchup, four cups of sugar, two cups of mustard, four tablespoons of granulated garlic salt, four tablespoons of Worcestershire sauce, and ⅔ cups of vinegar, may be blended, forming an end product.

Southern Delight salad dressing 110 has a delicious and flavorful taste and may be used in a variety of foods. Southern Delight salad dressing 110 may be poured over a salad 120 and thereby improve and enhance the taste of the salad 120 and help support the healthy consumption of more salad. Southern Delight salad dressing 110 may also be used in the preparation of other dressings and sauces, as a dipping sauce for vegetables, for meat, pasta salads, sandwiches, dips and spreads.

Referring now to FIG. 2, a perspective view illustrating Southern Delight 100 according to an embodiment of the present invention of FIG. 1.

The Southern Delight salad dressing 110 may be stored in a sealed container 200. The Southern Delight salad dressing 110 may be placed in a glass container 200 under refrigeration until it is to be used. However, Southern Delight salad dressing 110 may be placed in a wide variety of suitable containers.

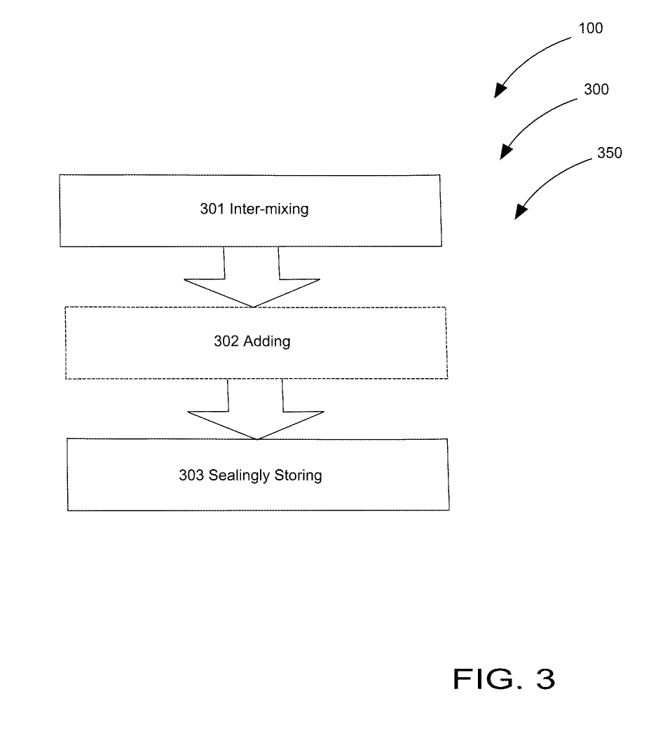

Referring now to FIG. 3, showing flowchart 300 illustrating a method of use 350 according to an embodiment of the present invention of FIGS. 1-2.

In accordance with the embodiments of the present invention a preferred method of use 350 is disclosed herein comprising the following steps: step one 301 intermixing two gallons of mayonnaise, one gallon of ketchup, four cups of sugar, two cups of mustard, four tablespoons of granulated garlic salt, four tablespoons of Worcestershire sauce, and ⅔ cups of vinegar and thereby producing a mixture; and step two 302 sealingly storing the mixture within a container. The end product Southern Delight 100 may be added to at least one salad and be eaten by the consumer.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A recipe for a Southern Delight salad dressing comprising ingredients combined in proportions substantially including:
two gallons of mayonnaise;
one gallon of ketchup;
four cups of sugar;
two cups of mustard;
four tablespoons of granulated garlic salt;
four tablespoons of Worcestershire sauce; and
⅔ cup of vinegar;
wherein said Southern Delight salad dressing is prepared by intermixing said two gallons of mayonnaise, said one gallon of ketchup, said four cups of sugar, said two cups of mustard, said four tablespoons of granulated garlic salt, said four tablespoons of Worcestershire sauce, and said ⅔ cup of vinegar.

2. A method of producing a Southern Delight salad dressing comprising the steps of:
intermixing two gallons of mayonnaise, one gallon of ketchup, four cups of sugar, two cups of mustard, four tablespoons of granulated garlic salt, four tablespoons of Worcestershire sauce, and ⅔ cup of vinegar and thereby producing a mixture; and
sealingly storing said mixture within at least one container.
